(19) United States
(12) Patent Application Publication
(10) Pub. No.: US 2002/0174011 A1
(43) Pub. Date: Nov. 21, 2002

(54) Systems and methods for conducting a loyalty program

(76) Inventors: Michael F. Sanchez, Hoboken, NJ (US); Paul Bannister, New York, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/099,914

(22) Filed: Mar. 14, 2002

Related U.S. Application Data
(60) Provisional application No. 60/275,961, filed on Mar. 14, 2001.

(51) Int. Cl. G06F 17/60

(52) U.S. Cl. 705/14

(57) ABSTRACT

Membership reward system for registering consumers as members of a membership reward program, and for providing offers to the members based upon the members' transactions with company partners of the membership program. Member participation is tracked and partners may be grouped into partner segments such that customized offers can be made to members based upon the partner segment to which the member is associated and the member's past transaction history and other information collected by the host (e.g., demographic information). The system also enables the preparation of reports and analysis regarding members, their purchases, and their purchase history.

### RELATED APPLICATION DATA

The present application claims priority from U.S. Provisional Application No. 60/275,961, titled “Systems and Methods for Conducting a Loyalty Program”, filed Mar. 14, 2001.

### FIELD OF THE INVENTION

The present invention relates to membership reward programs, and more particularly, to membership reward programs providing cash-back deals, gift cards, special discounts, products, non-cash incentives and exclusive offers when a member purchases goods or services from partner companies.

### BACKGROUND OF THE INVENTION

Incentive award programs, in which incentive companies contract with sponsoring companies for programs to promote sales of the sponsoring companies' products or services, are well known. Incentive programs include discount coupon programs; customer loyalty programs, such as frequent flyer programs, and promotional games, such as sweepstakes prizes, scratch-and-win games, and the like, in which a sponsoring company's products or services are won by successful participation in the incentive program.

Incentive programs offer awards and incentives to modify behavior of individual consumers and to direct the consumers to some pre-determined action, such as purchase of products or services upon visiting a retailer, viewing advertising, testing a product, or the like. Companies use awards and incentives to increase awareness of product offerings, to launch new products, to attract the attention of a newly identified audience, to differentiate products to encourage certain behavior, to obtain information, and for other purposes.

The introduction of the digital computer and the computer network eliminated some of the inconveniences of conventional incentive programs, particularly those that relate to data tracking and manipulation. The digital computer is a powerful data processing tool that allows a user to organize, store and analyze data at volumes and rates that would be impossible by any prior known techniques. Computers have been used in connection with incentive programs and other programs that have characteristics in common with incentive programs, but known computer incentive programs address some, but not all of the drawbacks of traditional promotions.

For example, U.S. Pat. No. 5,053,955 to Peach et al. discloses an improved process of printing and assembling coupons. More specifically, Peach et al. discloses a computer-based system for merging certain information for various promotions, so that a single stream of data can be used as a source for printing and mailing coupons for multiple promotions. Thus, the system of Peach et al. reduces some of the paperwork associated with a single-promotion systems, but it merely mitigates, rather than solves, the problems inherent in paper-based promotions.

Computer-based systems exist for tracking some aspects of consumer participation in incentive programs. For example, U.S. Pat. No. 5,056,019 to Schultz et al. discloses an automated purchase reward accounting system and method. In particular, Schultz et al. discloses a marketing method for providing manufacturer purchase reward offers by automatically tracking the purchases of member consumers through the use of bar-coded membership cards and using the purchase records in a data processing system to determine if the required purchases have been made to earn a reward. Each member consumer receives a reward booklet disclosing the available reward offers, a periodic status report indicating the member consumer's progress toward earning rewards, and a reward certificate for those rewards earned. The card-based system of Schultz takes advantage of certain data processing capabilities of computer systems and certain data storage capabilities of electronic card technologies; however, among other drawbacks, the system of Schultz does not address the need for a system that assists sponsor companies in generating incentive programs, in tracking participation of consumers in multiple incentive programs, or in fulfilling awards. Additionally, Schultz does not provide consumers attractive offers dynamically generated for particular consumers based upon a real-time or near-real time transaction history of that particular consumer's purchases from partners.

One of the most widely accepted and heavily used networks is the Internet. The Internet is a global system of interconnected computer networks formed into a single world wide network. A user, through the Internet, can interactively transmit messages with users in different countries. Similarly, a user in the U.S. connected to files and libraries and other jurisdictions such as Europe and Asia, can download files for personal use. Accordingly, the Internet computer network provides strong communications functions similar to the communications functions provided by ham radio operators.

Although some computer incentive programs are offered on the Internet, such systems are generally offered by a single sponsor and are generally limited to offering consumers the ability to participate in incentive programs. Known systems do not offer sponsors the ability to conveniently generate incentive programs, to track participation of consumers in multiple incentive programs, or to provide for automated fulfillment of awards. Another important drawback of known computer incentive program systems is that the obligation to fulfill the awards promised in a promotional campaign is often a logistically difficult and expensive task. The coordination of delivering or arranging for the retrieval of the awards for the specified winner, in volumes that permit successful incentive programs, requires coordination of prize inventory, systems and information.

For example, U.S. Pat. Nos. 5,774,870 and 6,009,412 describe an integrated on-line frequency award program accessible to an on-line user and through which the on-line user may browse a product catalogue. The program calculates award points, updates the award account of enrolled users, and communicates that number of awarded points to the user. Additionally, enrolled users can browse through an award catalogue and electronically redeem an amount of awarded points toward an award. The purpose of the on-line award programs disclosed by the '870 and '412 patents is to provide points immediately after an on-line purchase is made by an enrolled user. However, the on-line award programs of the '870 and '412 patents are limited to redeeming points for purchases made from on-line, Internet retailers. Furthermore, although the on-line programs of the '870 and '412 patents describe Internet award programs through which an enrolled user can accumulate and electronically redeem points for awards, the '870 and '412 patents fail to disclose or teach the dynamic creation of opportunities and offers for users based on past transaction history such that enrolled users receive offers from a particular class or subset of program partners. Therefore, the awards are not customized to persuade enrolled users into purchasing from a particular program partner or to purchase a particular item.

Another system that addresses award fulfillment is disclosed in U.S. Pat. No. 5,025,372 to Burton, et al. Burton et al. discloses a system and method for administration of incentive award programs through letters of credit. In the Burton et al. system, a computer system for an incentive award program allocates monetary amounts available for expenditure through credit instruments issued to program participants when the participants perform to a designated level of achievement. Participant's identifying information and credit instrument account numbers are stored in memory. Levels of performance are calculated and assigned for each participant in order for a monetary amount to be available for expenditure through the participant's credit instrument. Calculations, adjustment and reporting concerning amounts allocated for instrument use, withheld amounts, instrument transactions and account balances are made. Calculations and printed invoices for payment by a financial institution to an incentive company based on credit instruments issued under the incentive program are made and are dependent upon the monetary volume of expenditures through the credit instruments, the total interest income on the credit instruments, and the number of instruments issued.

The system of Burton et al. takes some advantage of a computer system for tracking data, but it has a number of drawbacks. Among other things, Burton et al. offers no advantage to a company sponsoring an incentive program in terms of the investment of skill and labor in developing an incentive program. Further, the complex letter of credit scheme of Burton et al. is likely to require participation of other entities, such as banks and attorneys in order for it to operate properly. Also, Burton et al. does not provide for tracking of data for participation of a given consumer in incentive programs of multiple program providers. Finally, Burton et al. does not provide a system for automated generation of offers dynamically generated based on the transaction history of a particular member.

Many existing promotional systems are also subject to the drawback that they require specific computer software or computer hardware to be purchased in order to participate in the incentive program. Historically, computer promotional games were of limited utility, because in order to participate the user was required to purchase specific software to participate in the incentive program, and no convenient mechanism existed to convey the information that the customer had won a prize to the party who was required to fulfill the prize. Computer networks, such as the Internet, offer a convenient solution to some of these problems, permitting easy transmission of such computer software for promotional games and easy transmission of information about the success of the consumer to the sponsoring company. However, current incentive program and award systems available over the Internet are quite limited. First, most such systems are limited to a specific type of incentive program or to products and services of a single sponsoring company. Also, most such systems rely on conventional mechanisms for award fulfillment, such as issuing a paper certificate to the customer by mail that is redeemable at a retail location of the sponsoring company.

Despite the conveniences in automation and communication offered by the Internet, certain aspects of the Internet are undesirable to many consumers. For instance, users that do not have Internet access, or whom are not computer fluent may not be able to access a computer based awards program. Furthermore, even where access may be obtained, consumers may have questions or issues that cannot be resolved on-line and without the aid of a customer service representative. Therefore, many service oriented Internet sites include customer service numbers to allow consumers to resolve issues off-line by speaking with a customer service representative. It is thus desirable for a web-based incentive program to include at least some methods of access and communication that are not Internet dependent.

Accordingly, a need has arisen for an incentive program and award fulfillment system that provides easy access to consumers, that allows the dynamic generation of offers based upon a user's transactional history and the many other facts known by the host, that provides for convenient tracking, reporting and analysis of member participation, that provides for convenient and automated award fulfillment and allows for award fulfillment either on-line or off-line.

### SUMMARY OF THE INVENTION

The present invention is a membership reward system for registering consumers as members of a membership reward program, and for providing offers and/or points to the members based upon the member's transactions with company partners of the membership program. The present invention also provides components which facilitate the administration of the membership reward program, including the tracking of member participation in the program, and the preparation of reports and analysis regarding members, their purchases, and their purchase history. The membership reward system includes at least one consumer, at least one partner, a communications network, and a membership reward system host. Additionally, the membership reward program may include at least one 3^{rd} party information provider. Although the communications network is discussed herein with reference to an electronic communication network, such as the Internet, it will be appreciated that the present invention may also be implemented using conventional communication systems and mechanisms, such as a telephone operating over a PSTN. The host manages the membership reward program in which consumers participate as members, and includes one or more servers in communication with consumers, partners and 3^{rd} party information providers via the communication network. The host also includes one or more databases for storing system and consumer data necessary to implement the reward program.

Briefly, the consumers participate in the membership reward program by registering as members with the host and thereafter purchasing goods or services from partners, which sell goods and services to the members, either in a conventional manner (e.g., a ‘brick and mortar’ store) or remotely, such as over the Internet or via conventional telephone catalog ordering. In addition, the customer can purchase an item from the partner and then provide unique production identifications codes to the host. Typically, the partners are retailers, consumer packaged goods companies, grocery stores, or service providers. Consumers register with the host via an Internet web site, telephone or forms. The information submitted to the host (referred to as the ‘member profile’) can include the member's name, address, telephone number, email address, credit card information, frequent shopper card information and/or membership tracking card information (collectively referred to as ‘member card information’), service account number, and the like. After receiving this information, the host stores the information in one or more databases. The collected member card information is forwarded by the host to the partners, who use the profile information to identify those members (anonymously) that purchase goods or services from the partners. Alternatively, production identification information provided by the customer after the time of purchase can be provided to the partner to validate any purchases. According to one aspect of the invention, the member profile attained at the time of registration is continually updated and augmented with information such as the member's transaction history (provided by partners from whom purchases are made or from the entity, such as the host, used to redeem points awarded to the member), 3^{rd} party information providers, member response to offers, and activities of the member, which may occur at a host Internet site, at a partner location, or the like.

In completing a purchase from a partner the consumer identifies themselves to a particular partner (passively or actively) through the use of a credit card, frequent shopper card, membership tracking card, or the like. Using a membership tracking or frequent shopping card will allow a consumer to identify their member profile and earn points while engaging in a cash transaction. Therefore, the member's card may be swiped and read by a card reading device to obtain the consumer's member profile, but the card (e.g., if a charge or credit card is used) or member account (e.g., if a membership tracking or frequent shopper card is used) will not be charged for the purchase if the member chooses to pay with cash. Alternatively, a member may use their membership tracking card or frequent shopper card to identify their member profile while also using a credit or charge card for payment in the same transaction. In such a scenario the consumer may swipe two cards to effect the transaction.

The partner identifies the consumer as a member of the membership reward system managed by the host, and in response, forwards transaction information regarding the member purchase to the host. The transaction information can include transaction history data and/or dimension data. Where transaction history data is generated by the partner at the SKU level, the partner can provide the host information such as the partner identity, brand purchased, the product purchased, the package type, and the quantity sold for each purchased item. Otherwise, the partner can simply forward transaction data which includes the partner identity, total transaction amounts, such as the cost and number of items sold, and the purchase date and store identification. In addition to transaction history data, the partner can transmit detailed dimension data that identifies information related to the member's purchasing history. Based upon rules provided by the host and/or the partner the consumer is awarded offers and/or points (herein referred to as ‘points’ or ‘the host points’) for the purchase.

On a continuous basis (e.g., hourly, daily, weekly, or monthly, etc.), the host generates partner segments to which it assigns members using the member profile information, which includes the member's transaction history. Depending upon the segment to which the member is assigned, the member is awarded and sent partner offers identifying the partner offers. The member may receive offers via the telephone, direct mail, the Internet, email or any other well known means, though email is preferred. Therefore, although the present invention is discussed herein with reference to offers emailed to members, this method of communicating offers is intended to be an illustrative and non-limiting example.

According to the invention, members can be assigned to one or more partner segments and can receive one or more offers from one or more partners. According to one aspect of the invention, members will receive a limited number of offers, such as 6 in a preferred embodiment, in each e-mail transmitted to the member, although it will be appreciated that any number of offers can be sent to each member. According to the invention, members are assigned to partner segments so that customized communications enticing the members meeting the specific criteria of the different partner segments may be sent in a single email to a member. For instance, as an illustrative example, where a particular member frequently purchases carbonated soft drinks, the member may be included within a ‘heavy soda consumer’ partner segment and may receive offers (e.g, coupons, free products, or points, as will be explained in detail below) from one or more partner soft drink manufacturers and/or grocery stores to purchase non-carbonated soft drinks so that the consumer will be encouraged to try new products. According to another aspect of the present invention, the frequency and location of offers within emails from a particular partner is based upon an agreement established between that partner and the host. Some partners may pay a premium to be present in all member e-mails whereas other partners may agree to be periodically included in e-mails based upon a rotation schedule. Partners may also pay a premium for a particular position within the e-mails, such that their offer is always the first one listed. Furthermore, partners have the ability to adjust their offerings based on response reports and analysis (e.g., response statistics) gathered by the host and provided to each partner, such that the offers can be dynamically generated. In addition, partners may be featured in emails based on each individual customer's proclivity to be influenced by an offer.

Offers typically comprise incentives and/or points that can be used by the member to purchase goods or services from the host or partners. Therefore, although the present invention is described herein with reference to points or incentives, it will be appreciated that both are offers provided to members and that the host or partner can configure the type of offer or reward made to a member.

Members may earn points by shopping at partner stores, purchasing from partner consumer package groups, using partner services and by performing point earning activities provided by the host or a partner, often as detailed in the offers transmitted to the member. For instance, points may be earned for registering with the host, or referring a member. According to one aspect of the invention, members are given opportunities to earn base points and/or bonus points. The point earning capability for particular acts may be communicated to a member either via an offer, via an e-mail not associated with an offer, via one or more the host web sites, or via a partner. The number of points to be earned for each purchase or point-earning action is based upon points-earning criteria, which may include information concerning the consumer, partner, purchase, act, as well as information provided by a 3^{rd} party information provider. The points-earning criteria can include information such as: demographics, geographical location, time, purchase behavior, web activity, amount, or partner store location. For instance, a consumer purchasing goods from a particular partner store during a sale may earn fewer (or greater) points than that consumer would have earned had the member purchased the same goods from the particular store not during the sale. As another example, a consumer who makes a high number of purchases from a particular partner store over a period of time may receive fewer points from the partner store than a consumer who infrequently purchases from the partner store, as the reward program would like to encourage the infrequent shopper to return to the partner store. It will therefore be appreciated that almost any combination of criteria can be used by the host based upon the exemplary criteria set forth above.

Members may also earn points upon establishment of a co-branded membership card or co-branded credit card. For instance, the host may enter into a relationship with a service provider such as a credit card company. In such a scenario the co-branded credit card identifies member card information to the host. When the co-branded card is established or used, the members may earn points. In such a scenario, double points may be awarded, including points for use of the co-branded card to purchase goods or services, and points for purchasing one or more items from a particular partner. A consumer could also earn points for using the co-branded card for purchases from a non-partner merchant or service provider.

Once sufficient points are accumulated, the consumer may redeem the points in exchange for cash, goods, or services from the host, the partner, or another entity that has agreed to provide something of value to the consumer in return for the points. According to one aspect of the invention, the customer can redeem the points from the host by accessing one or more Internet web pages established by the host that presents goods for purchase using the points. Alternatively, the consumer may redeem the points by calling a customer service representative of the host and ordering goods selected from a rewards catalog, which may be mailed to the member or provided on one or more host Internet web pages. According to another aspect of the invention, the packaging and shipping of the items selected by the member using the points are controlled by the host.

In addition to providing offers and points to members, the host can also generate and provide reports and analysis to the partners. According to one aspect of the invention, the reports may be generated in real-time in response to partner requests, where the partner requests are received over the Internet at one or more host report and analysis web pages. In such an embodiment partners may be provided with a web-enabled, password protected account that gives the partners access to the real-time reports and ad-hoc query capability, which may be used by the partners to maximize their marketing campaigns. Although reports may be requested and received by partners over the Internet, it should be appreciated that the reports may be requested by the partners via telephone, or sent on a regular basis to the partners via mail. The reports may also be generated automatically after the occurrence of a particular event, such as a sale or a round of offers. Additionally, it should be appreciated that the reports and analysis could be provided or sold to 3^{rd} party information providers. However, this may not be preferred or may be subject to partner authorization because such a sale may compromise the confidentiality of the information.

The present invention offers a number of advantages over prior art systems. For instance, the present invention allows each partner to meet its own marketing goals by focusing incentives on those customers that are likely to be receptive to the partner offers. Additionally, the process is transparent to the member because the partner identification of the member, and forwarding of transaction information to the host, is based on member card information that is typically used by the member at the point of sale regardless of the consumer's membership in the loyalty program. Additionally, because the host obtains greater amounts of information about each member with each transaction that takes place, the accuracy with which tailored offers can be generated constantly increases.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating the basic components of the Membership Reward System of the present invention.

FIG. 2 is a block diagram of the host, which manages the membership reward system, according to one aspect of the present invention.

FIG. 3 is a block diagram illustrating key features of the present invention.

FIG. 4 is a block diagram illustrating registration, according to one aspect of the present invention.

FIG. 5 is a block diagram illustrating a member profile, according to one aspect of the present invention.

FIG. 6 is a block diagram illustrating campaign management, according to one aspect of the present invention.

FIG. 7 is a block diagram illustrating a points-earning example, according to one aspect of the present invention.

FIG. 8 is a block diagram illustrating points earning, according to one aspect of the present invention.

FIG. 9 is a block diagram illustrating redemption, according to one aspect of the present invention.

FIG. 10 is a block diagram illustrating an embodiment of the system of the present invention, in which a host marketing module is a distinct element of the system.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, car; be implemented by special purpose hardware-based computer systems that perform the specified functions or steps, or combinations of special purpose hardware and computer instructions.

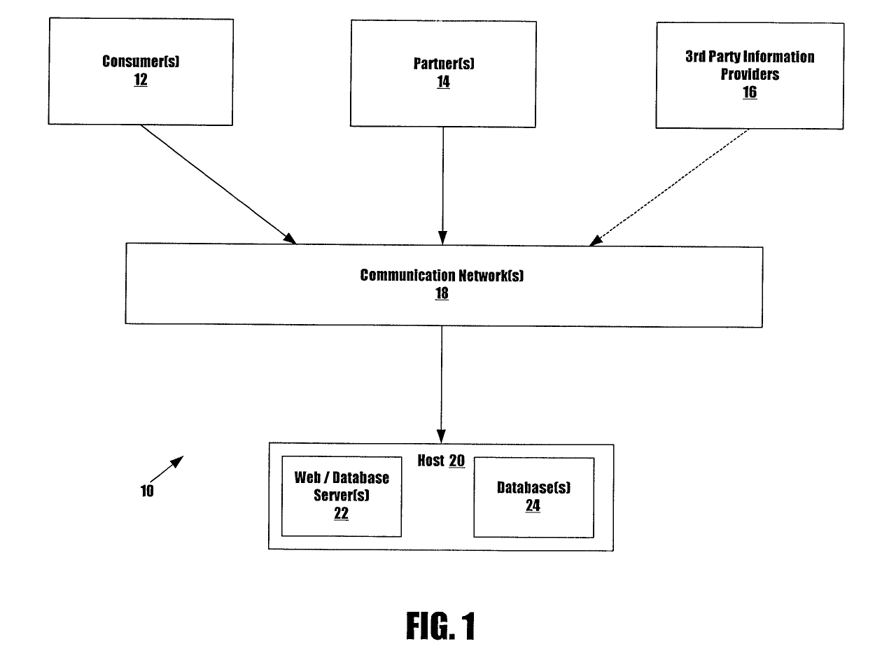

The present invention is a membership reward system for registering consumers as members of a membership reward program, and for providing offers to the members based upon the member's transactions and other information collected by the host (e.g., demographic information) with partners to the membership program. The present invention also provides components that facilitate the administration of the membership reward program, including the tracking of member participation in the program. FIG. 1 shows a schematic diagram illustrating the basic components of the membership reward system 10 of the present invention.

As illustrated in FIG. 1, the membership reward system 10 includes at least one consumer 12, at least one partner 14, a communications network 18, and a membership reward system host identified in FIG. 1 as the host 20. Additionally, the membership reward system 10 may optionally include at least one 3^{rd} party information provider 16. Although the present invention will be described herein with respect to the communications network 18 being the Internet, it should be appreciated that the present invention may be implemented without the Internet where the communications network 18 represents a public switch telephone network (PSTN), postal mail, private carrier, local area network (LAN), cellular or satellite service, or other communication means well known to those of skill in the art. According to the invention, the host 20 manages the membership reward program in which consumers 12 (also referred to herein as members 12) participate, and may include one or more servers (e.g., one or more computers) 22 in communication with the communications network 18, and one or more databases 24 for storing system and consumer data necessary to implement the reward program. Briefly, the consumers 12 participate in the membership reward program by purchasing goods and/or services from partners 14, which typically sell goods and services to the consumers 12, either in a conventional manner (e.g., a ‘brick and mortar’ store) or remotely, such as over the Internet or via call-in catalog ordering. FIG. 1 illustrates this purchase-sale relationship with a double-pointed arrow between the consumers 12 and partners 14. The host 20 rewards the consumers 12 for participation in the program by calculating and providing special offers and/or redeemable points to the consumer.

According to one aspect of the invention, the membership award program administered by the membership award system 10 resides in computer software at the host 20 and is accessible by consumers 12 over the Internet. In such an embodiment, the consumer 12 may be in communication with the host 20 using a computer having an Internet browser thereon. Typically, the consumer 12 computer is equipped with a web browser that permits the consumer computers to view HTML, pages, which are preferably displayed in graphical format. Well-known web browsers such as Netscape navigator and Microsoft Explorer automatically format data that is programmed in the HTML language according to well-known protocols. Information is transported back and forth between the consumer computer and the host 20 according to a well-known protocol known as the HyperText Transport Protocol. The messages sent according to the HTTP are addressed according to Uniform Resource Locators (URLs), which determine where the Internet resource is and which protocol to use to access the resource. Other protocols, such as FTP, are also available.

According to one aspect of the invention, messages are sent from a consumer 12 computer to one or more servers at the host 20, which includes a web server and/or HTTP server. As is well known in the art, a web server may have installed on it files that include HTML documents or may dynamically generate HTML documents that can be displayed on the consumer's 12 computer screen when accessed from a consumer 12 computer. Thus, without the need for any hardware or software, other than a standard personal computer and a common web browser, a consumer can access dynamic applications and content that are stored at the host 20.

According to the invention, a consumer's 12 computer (not illustrated) may include various standard components, including a central processing unit and associated read-only memory (ROM), both of which are connection along data and address bus lines to a random access memory. Also connected to the RAM, the CPU and the ROM via the bus are an input/output interface (I/O) and I/O device. The CPU is operatively connected to the I/O interface to control any corresponding I/O devices. Typical I/O devices may include a video display, a keyboard, a scanner, a mouse or joystick or other input or output devices. The consumer computer 12 may also include a storage device, which may be any conventional device for storing data, such an external hard disk. The consumer 12 computer further includes a system for connection to the communications network 18, which may be a modem. The consumer 12 computer is thus equipped similarly to any typical personal computer that can access the Internet. Additionally, installed on the consumer 12 computer is an operating system that controls various applications of the consumer 12 computer. Applications include applications for data management, storage and retrieval, a web browser application that is capable of formatting HTML documents, a communications application capable of controlling communications between the consumer computer and the communications network 18.

Referring again to FIG. 1, the partners 14 and optional 3^{rd} party information providers 16 are in communication with the host 20 via the Internet, or via an alternative communications network 18 as discussed previously herein. Therefore, it should be appreciated that the system 10 may also be administered via virtually any communications network, such as a public switch telephone network, a private local area network, or the like. Additionally, the communications network 18 can represent a combination of multiple networks facilitating the transmission of information. It should also be appreciated by those of skill in the art that a single or common communications network 18 does not have to be used by each of the components in the system 10. For instance, the communications network 18 may vary depending upon the type of communication transmitted in the system 10, the element transmitting the communication, or the element receiving the communication. As an illustrative example, a communication may be transmitted from a consumer 12 to the host 20 using the Internet, whereas a particular response from the host 20 to the consumer 12 may occur over a PSTN. For instance, a consumer may purchase one or more goods from the host via the Internet, using the points-earned from the host 20, which are then shipped to the consumer in a conventional manner.

As illustrated in FIG. 1, the host 20 comprises one or more web and/or database servers 22 in communication with at least one database 24. The database servers 22 may also represent call-center servers through which a member can communicate with the host. For instance, the database server 22 may represent a customer service representative that keys in member or transactional information into a computer system that can communicate with one or more databases to effect storage of member, partner or host-generated information. Therefore, although the present invention is described herein with respect to the web and/or database server 22 being a web server, it will be appreciated that the present invention can be effected with conventional communication mechanisms for receiving and processing information, and without the use of a web server.

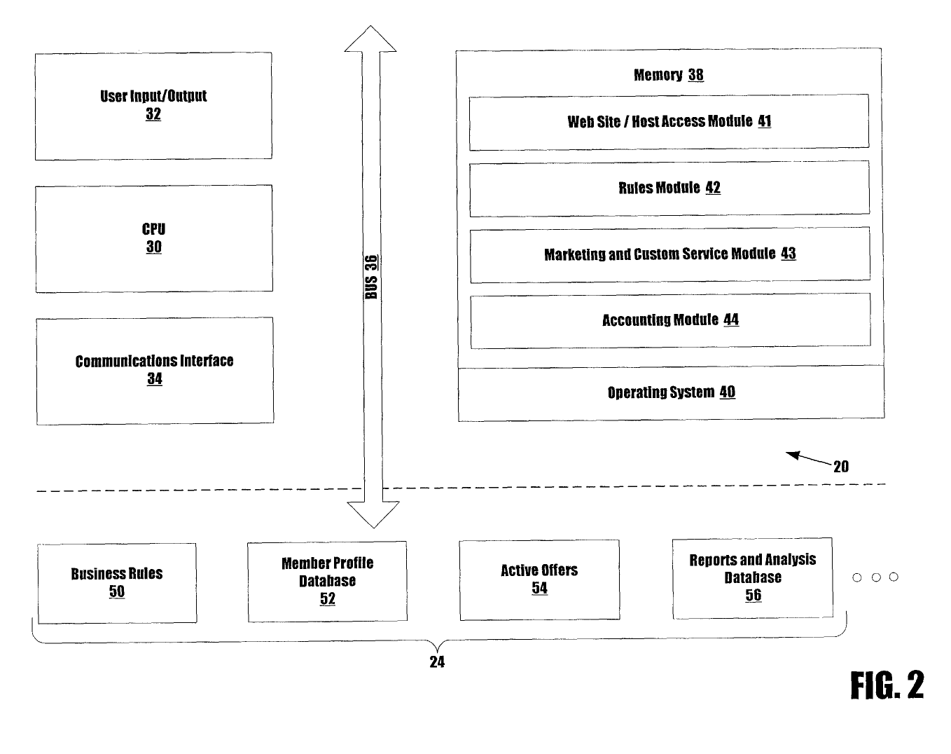

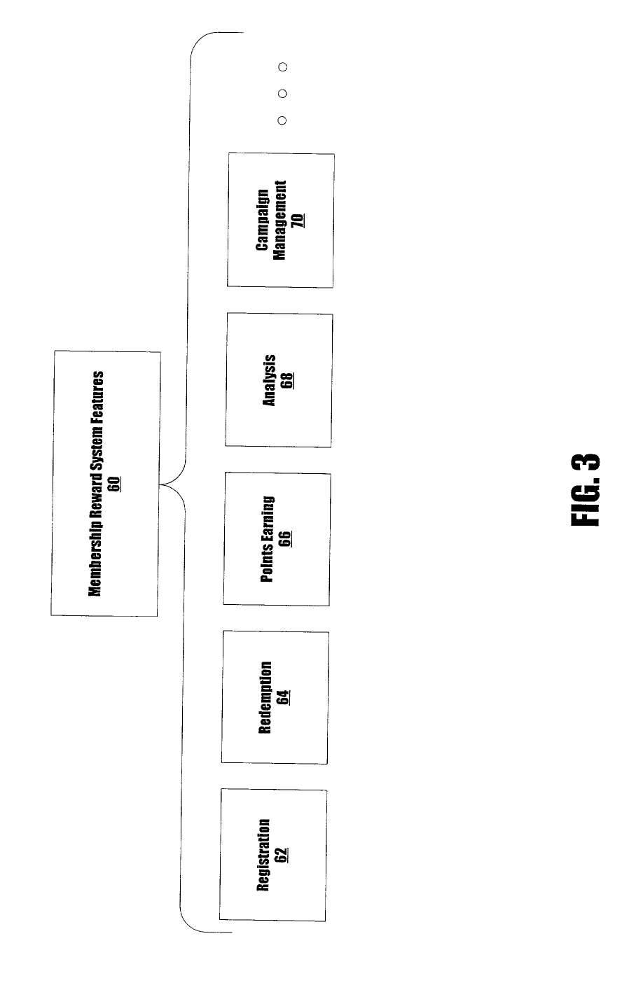

One embodiment of the host is illustrated in FIG. 2. As shown in FIG. 2, the host 20 comprises a CPU 30, a User I/O device (e.g., keyboard, display device, etc.), a communications interface 34 (for interfacing and communicating with other elements of a network), a BUS 36, a memory 38, an operating system 40, and a plurality of databases 24. A number of program modules may be stored by the memory 38, including a web site module 41, a rules module 42, a marketing and customer service module 43, and an accounting module 44. The web site module 41, rules module 42, marketing and customer service module 43, and accounting module 44 control certain aspects of the operation of the host 20, as is described in more detail below, with the assistance of one or more CPUs and operating systems, such as the CPU 30 and the operating system 40. The features and functions of each module 41 42, 43, 44 will be discussed in detail with respect to the block diagrams of FIGS. 3-9.

Briefly, the web site module 41 provides the communication interface to enable consumers to access the host 20 web sites via the Internet, and provides the Internet on-line experience experienced by members, including providing the graphical user interfaces (GUIs) that enable consumers to register and redeem points on-line. The rules module 42 calculates member's points after comparing offers to member transactions. The marketing and customer service module 43 provides for and manages multiple membership reward system 10 features, including partner offers, partner segmentation categories, customer service, member registration, maintenance of member profiles, call center management, and call center marketing (e.g., outbound e-mailing and reporting), including reporting and analysis. Finally, the accounting module 44 provides for point accounting and invoicing. The modules 41, 42, 43, and 44 manage multiple functions of the membership award program with the aid of a plurality of databases 24. Four illustrative databases are shown in FIG. 2, including a business rules database 50, a member profile database 52, an active offers database 54, and a reports and analysis database 56. However, it will be appreciated by those of skill in the art that additional databases may exist for implementing the functions of the system 10 as described herein.

The memory 38 in which the modules 41, 42, 43, 44 reside may comprise random access memory, read-only memory, a hard disk drive, a floppy disk drive, a CD Rom drive, or optical disk drive, for storing information on various computer-readable media, such as a hard disk, a removable magnetic disk, or a CD-ROM disk. Likewise, the databases 24 may also comprise such computer-readable media. As will be appreciated by one of ordinary skill in the art, each of the modules 41, 42, 43 and 44 are connected to the bus 36 by an appropriate interface. The modules and databases 24 and their associated computer-readable media provide nonvolatile storage for the host 20. However, it is important to note that the computer-readable media described above could be replaced by any other type of computer-readable media known in the art. Such media include, for example, magnetic cassettes, flash memory cards, digital video disks, and Bernoulli cartridges. It will be appreciated by one of ordinary skill in the art that one or more of the host 20 components may be located geographically remotely from other host 20 components. Furthermore, one or more of the components may be combined, and additional components performing functions described herein may be included in the host 20. The functions of the present invention will next be described in detail with reference to block diagrams describing the exchange of information between the individual elements of FIG. 1, as well as the elements that comprise the embodiment of the host illustrated in FIG. 2.

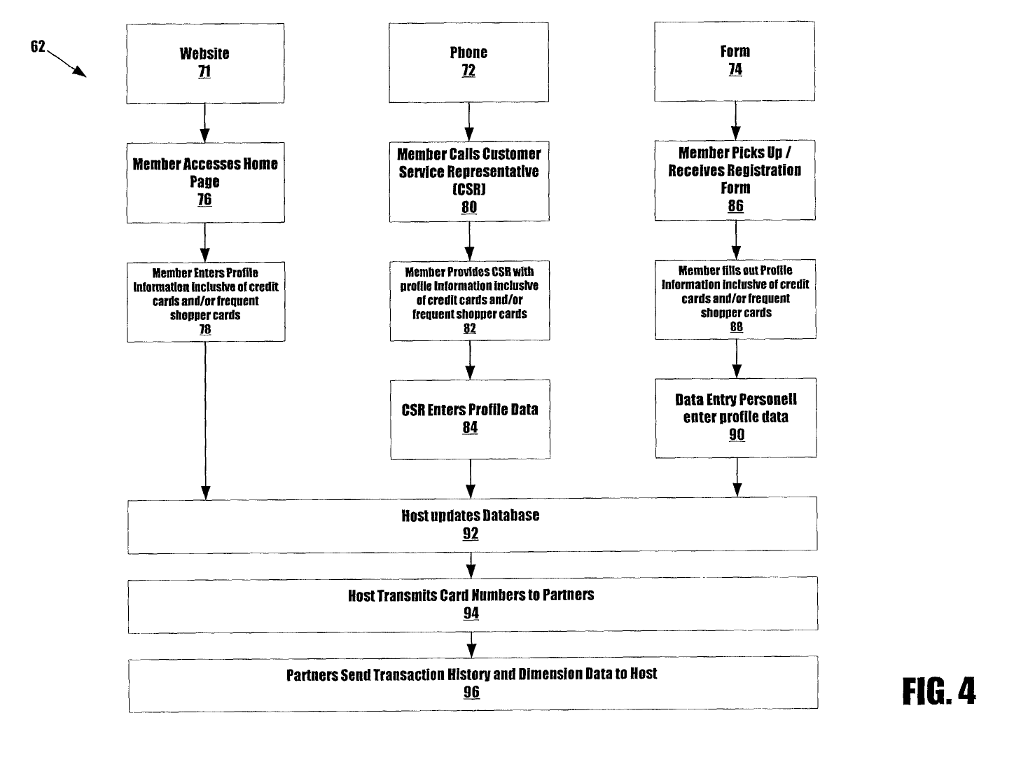

FIG. 3 shows five primary features or functions 60 implemented by the membership reward system of the present invention, including registration 62, analysis 68, redemption 64, points earning 66, and campaign execution 70 (also referred to herein as campaign management). An additional feature, report generation, will be described in detail after each one of the five features illustrated in FIG. 3 are discussed with reference to FIGS. 4-9.

FIG. 4 illustrates the registration 62 function. As illustrated, consumers can register as members of the membership reward system of the present invention via a web site 71, phone 72, or form 74. According to one aspect of the invention, membership forms may be distributed by local chapters or organizations, such as community groups. Where a consumer wishes to register via a web site, the consumer accesses the web server 41 of the host 20 using a computer in communication with the host over the communications network 18. The web site module 41 provides the consumer with a home page, which comprises a GUI stored within the web site module 41 or one or more of the plurality of databases 24. Using the GUI, the consumer enters membership profile information to generate a member profile. The member profile information can include the member's name, address, city/town of birth, number of children, year of birth of youngest child, e-mail address, telephone number, user name, password, and member card information. After receiving this information, the host 20 stores the information in the member profile database 52 and validates that the member card information is valid This process typically includes contacting the card provider to ensure that the card is valid, as is well known in the art. Thereafter, the member card information is forwarded, along with a corresponding member identifier, to each of partner 14, preferably, via the Internet, although any communications network 18 may be used. The member card information is forwarded by the host to the partners so that the partners can anonymously identify those members that purchase goods or service from the partners. Additional member profile information can also be sent to the partners, such as the member name, identity, etc. The host 20 therefore stores location and/or contact information for each partner within the one or more databases 24 such that the web site module 41 or another module, such as the marketing and customer service module 43, can provide each partner 14 with the member card information 94 via the communications interface 34 and communications network 18. After the partners 14 receive the member card information 94, the partners can thereafter forward transaction history and dimension data to the host 20.

As illustrated in the flow chart of FIG. 4, consumers may also register with the host 20 via telephone 72. In such a scenario, the consumer dials a customer service telephone number established by the host 20 and communicates member profile information to a customer service representative 82, who can input the information into the member profile database 52 using the user input/output device 32. Just as in the web site embodiment, the member profile is thereafter transmitted to partners over the communications network 18, after which the partners 14 can identify the member and transmit transaction history and dimension data to the host 20. In a similar embodiment, a consumer can register with the host by filling out a form 74, 86, 88, which the consumer may have picked up at a mall kiosk, shopping center, partner stores, or received in the mail. Like the telephone registration embodiment, a customer service representative or a data entry person associated with the host 20 can enter the member profile information such that the member profile database 52 may be updated. The data entry personnel inputting such information 90 may be local to the host 20 or geographically distant from the host 20 and in communication with the host 20 via the communications network 18. Again, after the member profile is updated, the member profile is transmitted to partners over the communications network 18, after which the partners 14 can identify the member and transmit transaction history and dimension data to the host 20.

According to one aspect of the invention, the member profiles are submitted to the partners on a regular basis, such as every night. However, it will be appreciated that the member profile information may be transmitted to the partners in real-time, each time an additional consumer creates a member profile. It should also be appreciated that the processes illustrated in FIG. 4 can apply to members having already established a member profile but wherein members wish to update the profile. Therefore, for example, a member wishing to update her member profile may do so by submitting, via a web site 71, phone 72, or form 74, either a new profile or changing or adding one or more profile components.

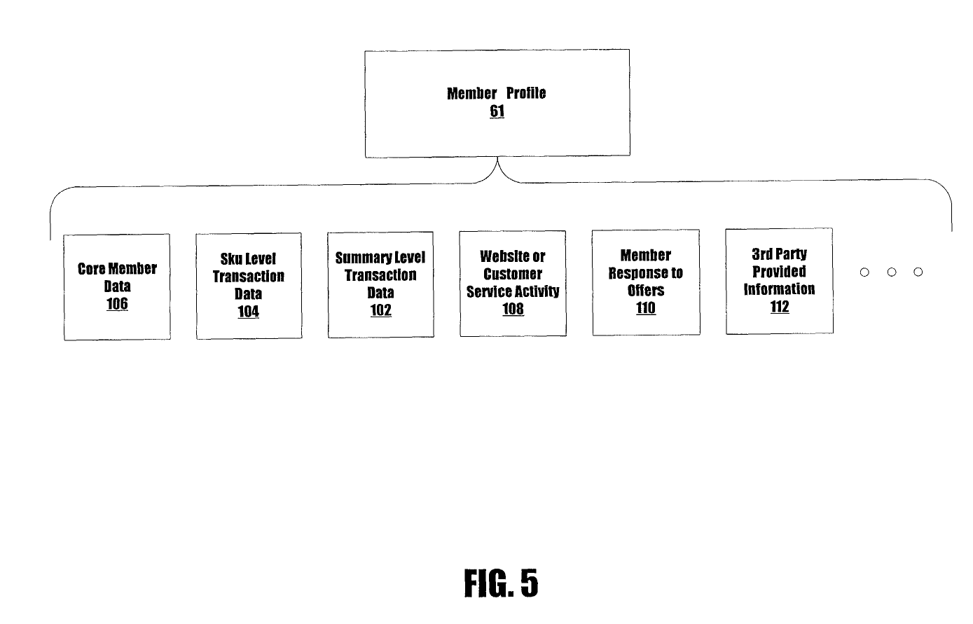

FIG. 5 illustrates at least some of the components comprising the member profile 61. Upon initially registering with the host 20, and prior to any further transactions with partners and/or the host, the member profile only contains that core member data 106 input by the consumer during registration 62. However, as shown in FIG. 5, the member profile 61 may also comprise a number of additional elements that may be provided by partners 14, 3^{rd} party information providers 16, or the host 20. Specifically, the member profile 61 comprises summary level transaction data 102, SKU level transaction data 104, the core member data 106, web site activity data 108, member response to offers data 110, and third party provider data 112. Additional information not illustrated may also be included in the member profile 6 1, such as customer service activity, activity of the member in local clubs or chapters, enhanced profile information, and the like.

The summary level transaction data 102 is transmitted to the host 20 from a partner 14 when the member utilizes a credit card or frequent shopper card when purchasing from the partner, and includes total transaction amounts, such as the cost and number of items sold, as well as the purchase date and partner identification information. Alternatively, SKU level transaction data 104 may be transmitted to the host 20 from a partner 14 when the member utilizes a credit card and/or frequent shopper card to make a purchase from the partner, and includes as the brand purchased, the product purchased, the package type, and the quantity sold for each purchased item. SKU-level information may be automatically obtained by partners using an automated point-of-purchase (POP) system, as is well known in the art. The web site activity 108 data is gathered by the host, and more specifically, the web site module 41, when the member accesses or views particular information at one or more host web sites, or engages in particular acts at the web site, such as filling out forms or surveys. Next, the member's response to offers may also be added to the member profile, such that a member's response or receptiveness to certain previous offers, or types of previous offers, may be included in the member profile 61. Finally, the ₃rd party provider data 112 can include virtually any information provided about the member, including income, profiling information, or virtually any information that may be useful in marketing or determining the marketing that is appropriate for a particular member (e.g., spending patterns, movement history, etc.), as is well known in the art. According to one aspect of the present invention, this variety of profile information is updated and/or added to the member's profile, and is stored in the member profile database 52. Therefore, each of the modules 41, 42, 43, 44 within the memory may contribute to the member profile, as well as partners 14 and 3rd party information providers 16 in communication with the host 20. As a result, the member profile 61 attained at the time of registration is continually updated and augmented with information that may be used to determine the offers and/or points provided to the member.

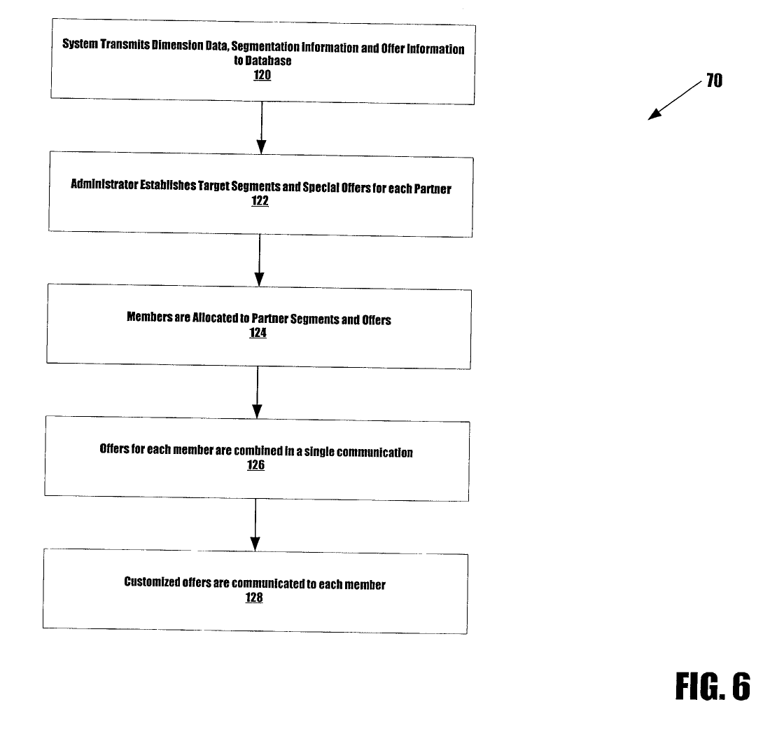

FIG. 6 illustrates the campaign management process 70, which utilizes the member profile 61 to generate offers to members. Because of the extensive amount of data regarding the member and the member's transactional history is stored within the member profile database 52, the campaign management process 70 can use the member profile 61 to generate tempting offers tailored to the member.

As illustrated in FIG. 6, the partners 14 each transmit to the host 20 dimension data, segmentation information and offer information 120. As previously indicated, the dimension data includes historical information regarding the member's purchasing habits, and may, according to one embodiment, contain the transaction data described in detail above. The segmentation information, on the other hand, is generated by each partner 14 and contains at least two fields in which members may be classified, typically where the fields are based at least in part upon one or more threshold values. According to one aspect of the invention, the threshold value may be the number of visits by a particular member over a period of time, such as a year. According to another aspect of the invention, the threshold value may be based upon a particular dollar amount of money spent on the partner by a member over a period of time. According to yet another aspect of the invention, the threshold value may be based upon both the amount of money spent at the partner per year and the average number of visits per month. It should be appreciated that these are only illustrative examples, and that virtually any criteria can be used by the partners to establish segmentation information. It will be also appreciated that each partner may utilize different criteria for categorizing consumers, such that one partner may have a large number of segments, whereas another partner may only have one or two. The segments may be communicated by the partners to the host via the communication network 18, and may be updated by the partners via a web site established by the host, or through the use of customer service representatives associated with the host. According to one aspect of the invention, partners may only change the segmentation information a limited number of times within a time period set by the host, such as once. According to another aspect of the invention, partners can change segmentation information as often as the partners desire, or a partner-defined number of times within a time period set by the host.

The offer information transmitted to the host 20 from each partner 14 identifies one or more offers the partner wishes to be presented to each consumer segment. Therefore, the offer information may indicate that a consumer in a first segment should receive a first offer, whereas a consumer in a second segment should receive a second offer. Although the offer information typically identifies at least one offer for each consumer segment, it is possible that the offer information will not include an offer for a given segment. For instance, where a consumer spends more than $1000/year on a particular partner, that partner may direct that the consumer receive no offer. Like the segmentation information, the offer information may be communicated by the partners to the host via the communication network 18, and/or may be updated by the partners via a web site established by the host, or through the use of customer service representatives associated with the host. Like the segmentation information, according to one aspect of the invention, partners may only change the offer information a limited number of times over a particular time period. Alternatively, partners may have unabated authorization to change offer information at any time where the partners pay the host for a right to make such changes. Additionally, the segmentation information and offer information need not be communicated from the partner to the host simultaneously. The manner in which member offers are established will next be discussed.

Referring again to FIG. 6, after the dimension data, segmentation information and offer information are transmitted by the partners 14 over the communications network 18 to the host 20, the data and information are stored in one or more databases 24. Although not illustrated in FIG. 2, the host 20 may include separate databases for the dimension data, segmentation information and offer information, although it will be appreciated by those of skill in the art that such information can be stored in any of the databases 24. The dimension data, segmentation information and offer information are then retrieved by the marketing and customer service module 43, which establishes target segments and offers corresponding to each segment 122. Although the offers information may be transmitted to the host each time segmentation information is transmitted, it will be appreciated that the offer or segmentation information may change independent of each other. For instance, in January a particular partner may provide a first offer to a first segment, and a second offer to a second segment. The partner may change the offer information in February without changing the segmentation information. Thus, in February the same segments exist, where the first segment may receive the same first offer, but the second segment may not receive an offer.

After target segments and corresponding offers are established by the marketing and customer service module 43, the marketing and customer service module 43 allocates members to partner segments and offers 124. The module performs this function by determining those members that fulfill each segment and offer criteria-based upon member profiles and/or dimension data. To effect this function, the module 43 can simply compare those member and/or dimension records that fulfill the segment and offer criteria. After members are allocated to segments and offers, the offers are combined for each member into a single communication 126 and then communicated to each member 128. Combining the offers into a single communication is helpful where a member would otherwise receive multiple emails containing offers from a plurality of partners. According to one aspect of the invention, a member may receive only a limited number of offers, rather than every offer the member has qualified for. In such a scenario the offers transmitted to the user may be based on those partners paying a premium to ensure their offer is transmitted. According to another aspect of the invention, one or more aspects of the member profile may be used to determine those offers that are most attractive to the member, where those offers receive priority over other offers. Additionally, according to yet another aspect of the invention, the host 20 tracks past offers made to consumers, with the aid of an offer database 54, to ensure that the same offers are not given to a member over and over again. Thus, an offer that has been previously presented to the member may get lower priority than offers that have not yet been transmitted to the member. It should be appreciated that limiting the number of offers is beneficial so that the consumer is not overwhelmed with communications from the host 20.

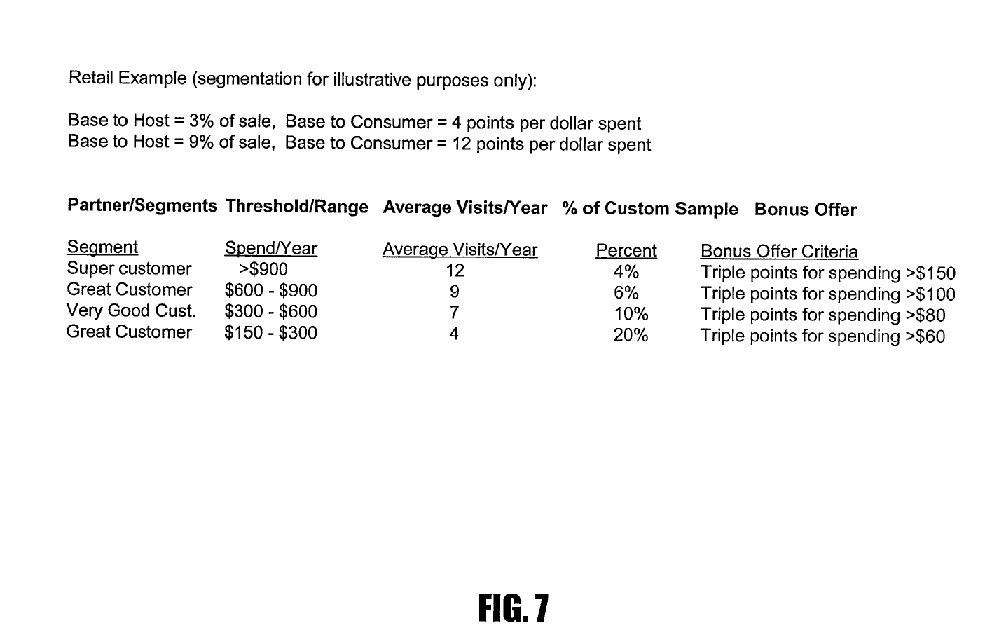

FIG. 7 is a block diagram illustrating a points-earning example, according to one aspect of the present invention. As illustrated in the figure, there are four segments: super customer, great customer, very good customer, and average customer. The segments are based upon a thresholds established on the dollars spent by consumers at the partner for the past year. For instance, the threshold levels for the respective segments are >$900, $600-$900, $300-$600, and $150-$300. Also illustrated is data that may represent dimension data, such as the average visits per year for each consumer in a particular segment, and the percent of consumers in a segment. Furthermore, FIG. 7 illustrates offer information provided by the partner, identified by the title ‘Bonus Offer Criteria’. Thus, for a ‘great customer’, the host will award triple points to a member spending over $100. Although not indicated, this $100 value would typically include a date or date range within the $100 must be spent to obtain the triple points. As indicated by the figure, the member (i.e., ‘Mom’) may typically receive 4 points for every dollar spent, unless the member meets the bonus offer criteria, after which the member will obtain triple points per dollar spent, or 12 points per dollar spent.

Also included in the illustrative example is a percentage which may be paid to the host by the partner, for both regular sales (not meeting any bonus criteria), as well as those sales meeting the bonus criteria. In the example, the host receives 3% of the sale price for regular sales, and 9% of the sale price for sales meeting the bonus criteria. Preferably the host receives a higher percentage of the sale price when a member meets the bonus criteria because the bonus criteria provided by the host played a crucial role in persuading the member to spend money on the partner.

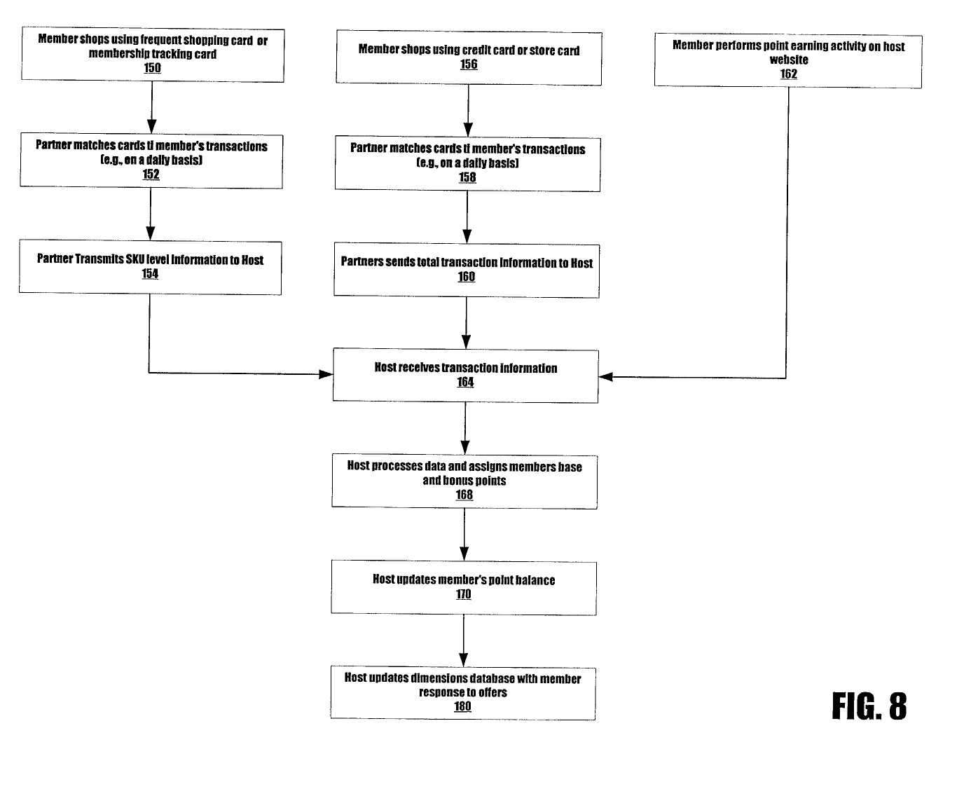

FIG. 8 is a flow chart illustrating three methods in which members earn points, according to one embodiment of the present invention. Although the first two methods illustrate the types of transactional information that may be transmitted to the host from a partner, it should be appreciated that detailed SKU level transactional information or less detailed transactional information may be transmitted to the host from a partner regardless of whether credit cards, store credit card, or frequent shopping cards are used by the consumer. Therefore, the methods of FIG. 8 are intended as illustrative, and are not intended to be limiting. As a first method, a member can shop at a partner location (e.g., store, web site, etc.) using a store card or a frequent shopping card 150. According to one aspect of the invention, in processing the transaction, the partner 14 will match those frequent shopping cards to the members transactions on a daily basis 152. Alternatively, the member may be identified immediately and the transaction information may be sent to the host in real-time or near-real time. Where the member uses a frequent shopping card to make a purchase from the partner, the partner 14 will forward transaction information, in this case, SKU level information 154 to the host, which receives the information 164 via the communications network 18. According to a second illustrative method, a member can shop at a partner location (e.g., store, web site, etc.) using a credit card 156. Like the first method, the partner 14 will match those frequent shopping cards to the members transactions, preferably on a daily basis 158. The partner 14 then forwards transaction information, in this case, information such as the date, store location and price of sale, to the host, which receives the information 164 via the communications network 18. The transaction information provided from the partner to the host in the second method is less detailed than in the first method, where the member uses a frequent shopping card. According to the third method illustrated in FIG. 8, the member can earn points by performing point earning activity on the host Internet site. For instance, members may earn points based upon actions such as registering, referring a member, or filling out a survey.

Regardless of the method used to earning points, the host utilizes the received transaction information 164 to update the member profile stored in the member profile database 52, and process the transaction information with the aid of the rules module 42 and business rules database 50. The rules module calculates the member's points 168, as is discussed in greater detail below. After the member's points are calculated the accounting module 44 then updates the member's points.

According to one aspect of the invention, rules for allocating points to members are based upon one or more criteria. For instance, demographics, such as the member's age or sex, may be used to establish rules for allocating points. Geographical information, such as where the member resides, may also be used by the rules module 42 to determine point allocation. Rules for allocating points may also be based on time, such as ranges of times, e.g., starting June 24^{th} and ending on July 5^{th}. Purchase behaviors may also be used to determine point allocations. For instance, partners may specify member segments having verbal descriptions that can be used to segment members into segments specified by the verbal segments. As an example, the segments can include: none buyer, frequent buyer, competitive buyer, or lapsed buyer. Partners can also provide calculations to define the segments. For instance, the partner can indicate that a ‘none buyer’ is someone who doesn't purchase brand ‘X’ soda, a ‘frequent buyer’ is someone that purchases 6-12 packs of brand ‘X’ soda a month, and a ‘lapsed buyer’ is someone who used to purchase 3+packs of brand ‘X’ soda per month and now purchases 1 or less packs of brand ‘X’ soda per month. Rules for allocating points can also be based on purchase amount, such that anyone purchasing more that $X from XYZ conglomerate (partner) gets 10 points. Additionally, points may be awarded to members that shop at a particular location.

Using these or similar criteria provided by the partners, the base and bonus points are calculated as described above with reference to the illustrative example of FIG. 7. To effect this calculation, the rules module 42 compares the active or existing offers, stored in the active offer database 54, to the member transactions. Although this could occur on a real-time or near-real-time basis, such that the rules engine continuously calculates member points after each and every transaction, it is preferred that this comparison be performed on a daily basis to minimize the processing power and communication bandwidth required to continuously update point totals. Thus, the rules module 42, with the aid of the business rules database 50, compares the transaction information stored in the member profile database (or another database separate from the member profile database for storing transaction information) to the active offers for which the member can obtain points. Because members can obtain base points for purchases that do not meet offer criteria, the active offer database 54 or business rules database 50 preferably contain a list of those partners from whom base points can be earned, and the value of the base points. For example, referring again to the illustrative example of FIG. 7, because 4 points are earned for each dollar spent for purchases not rising to the level to satisfy the bonus offer criteria, these points should be awarded and added to the member point total. Once the base points are calculated, the rules module 42 compares the transaction information to the bonus criteria (i.e., offer information) to determine whether any such criteria are met. Where criteria are met, the rules module 42 calculates the bonus points and adds the bonus points to the base points to produce a new point total.

Alternatively, according to one aspect of the invention, when bonus points are awarded other rules for awarding points, such as base points. are not applied. Additionally, it should be appreciated that additional rules may apply, such as origin rules, whereby bonus points or a percentage of points are awarded to a member based upon the highest rule that applies. For instance, where credit cards use may result in a member earning double points, the double points will be awarded even though the member is purchasing a high enough total to provide bonus points of one and a half points for each regular point earned. Thus, the highest total is provided to the member.

It should also be appreciated that the offer database may be updated, if need be, to eliminate offers used by the member. For instance, where an offer is only outstanding as a one time use, or the member has otherwise permanently satisfied the offer, the offer should be removed from the active offer database or a similar notation should be made in the member profile to indicate that the member cannot satisfy the offer again. The total points are then transmitted to the accounting module 44, and the member profile is updated with the new point total.

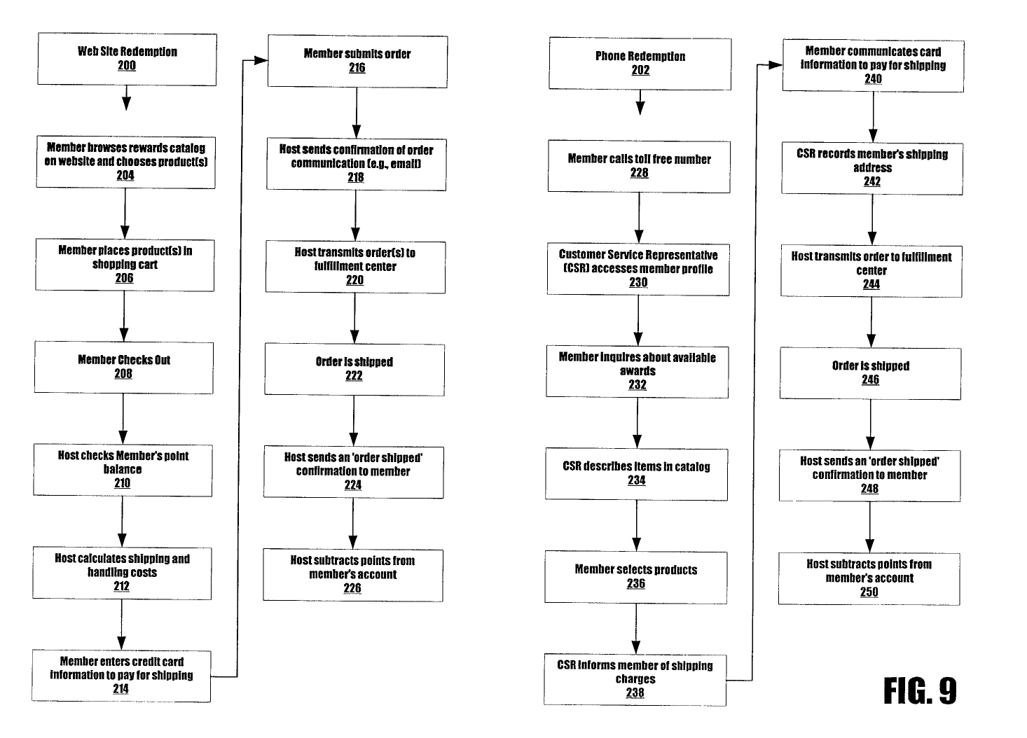

FIG. 9 shows a flowchart illustrating point redemption methods, according to one aspect of the present invention. A first method in which a member may redeem points is through access to the host web site 200. After accessing the host web site the member can browse rewards catalogs and choose products 204. According to one aspect of the invention, the member can browse only those items that may be purchased by the member's current point total. According to another aspect of the invention, the member may search classes of goods based upon the type of good or the value of the goods. For instance, the member may search for goods having a value of greater than 10 points, but less than 50 points. After selecting an item, the item is placed in a virtual shopping cart 206, as is well known in the art, and the member can check out 208. Upon check out, the member's point total is verified 210 by the accounting module 44 or marketing and customer service module 43 to ensure that the member has sufficient points to purchase the selected product. After verification of sufficient points, shipping and handling costs are calculated 212 by the accounting module 44 and the user is asked by the web site module 41 for credit card information 214 to pay for shipping and handling charges. After this information is entered into the GUI provided by the web site module 41, the order is submitted by the member 216 using a web-based GUI and the system confirms that the order has been accepted 218. Thereafter the accounting module 44 transmits the order to a fulfillment center 220, which ships the order 222 and transmits an order shipped notice 224 to the member via email or letter, and preferably, via the marketing and customer service module 43. Finally, the points for the ordered item are subtracted from the member's account 226 by the accounting module 44, and the member profile is updated with the new point total.

According to an alternative method of redeeming points, a member may call a toll free number 228 and identify themselves as a member to a customer service representative. After the customer service representative accesses the member's profile 230 from the member profile database 52, the member can ask the customer service representative about the awards available 232 to the member, or awards which the member has yet to qualify, and the customer service representative can respond by describing the available items 234, which may be listed in a catalog or accessible by customer service representative from the host Internet site. After the member selects one or more items 236, the customer service representative can inform the member of the shipping and handling charges 238, and the member can communicate the member's credit card information to pay for the shipping and handling charges 240. After the customer service representative records the members shipping address 242(or obtains the members address from the member profile database 52), the order is transmitted to the fulfillment center 244, which ships the order 246 and transmits an order shipped notice 248 to the member via email or letter, and preferably, via the marketing and customer service module 43. Finally, the points for the ordered item are subtracted from the member's account 250 by the accounting module 44, and the member profile is updated with the new point total.

According to one aspect of the invention, the host allows partners to generate reports to enable feedback to the partners regarding the status of offers, segmentation data, and the like. The reports may be generated by the host using the marketing and customer service module 43 and/or the accounting module 44, and may provide data to the partners in an anonymous fashion such that the members are not identified in the reports. According to one aspect of the invention, the reports are generated on an ad-hoc basis by queries submitted to the host from one or more partners. Preferably these ad-hoc queries can be requested by accessing the host Internet site, or by accessing an extranet site established by the host. The ad-hoc searching capability allows partners to generate customized detailed reports on countless aspects related to customer transactions with the partner, the partner's customers, partner offers, and segmentation. For instance, partners can generate reports detailing the products purchased by customers, the demographics of customers purchasing from the partners, and like material, such that the partners can use the reports to further tailor offers and for marketing purposes.

The reports may also be based upon pre-established reporting criteria, and may be provided to the partners at a specified or predetermined interval. According to one aspect of the invention, some reports with basic information may be provided to the partners for free, while other reports may be provided only for a fee.

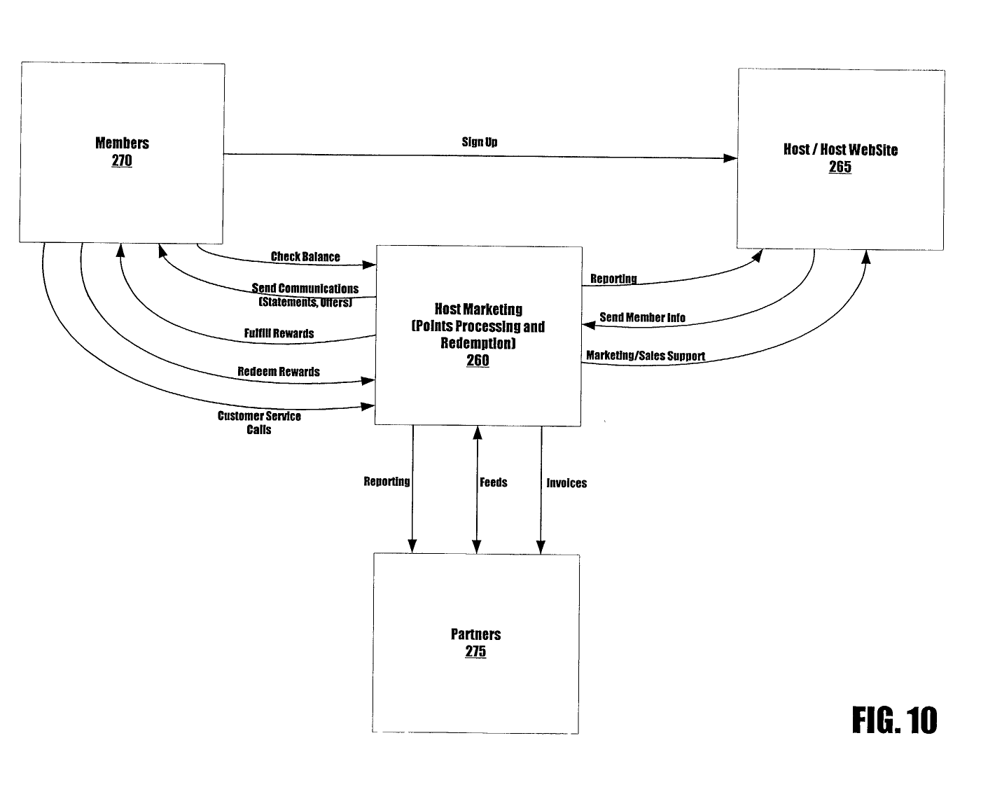

FIG. 10 is a block diagram illustrating an embodiment of the system of the present invention, in which a host marketing module is a distinct element of the system. As illustrated in FIG. 10, the system of the present invention may be integrated with a pre-existing affinity program. Therefore, components of the present invention can be used to create a loyalty program for a company that has an established two-way customer communication capability or pre-existing web site enabling such customer communication capability. As illustrated in FIG. 10, the present invention is segregated such that the reward system rules, accounting, offers, statements, marketing, rewards, and points allocation and redemption functions are maintained in a separate host marketing component 260 that communicates with members 270, a host or host web site 265. and loyalty program partners 275. According to one aspect of the invention, the host or host web site 265 is a pre-existing entity to which the present invention can piggyback for communication with the members and for pre-existing hardware and system features. As illustrated by the process flows in FIG. 10, the system of FIG. 10 includes each of the functions of the present invention described previously above. Therefore, it may be entirely transparent to members 270 that the host marketing component is separate from the host or host website 265.

As illustrated in FIG. 10, members 270 initially sign up or register with the host 265 such that the host can effect communications with the members and obtain requisite identification and member profile information provided by the members 270. Thereafter the host marketing component 260 enables the provisioning of the loyalty program by communicating with the members 270, host or host website 265, and loyalty program partners 275. As illustrated, the host marketing component 260 sends feeds to and receives feeds from the loyalty program partners 275, where the feeds to the loyalty program partners 275 include member and offer-related identifying information and the feeds from the loyalty program partners 275 include transaction and segmentation information.

As illustrated, the host marketing component 260 provides the loyalty program rules, point allocation and redemption, loyalty program customer service and related functions associated with establishing the loyalty program described herein. However, the host marketing component 260 need not establish and query members for identification information where the host or host website 265 already stores such information. The host marketing component 260 therefore sends communications, such as offers, to the members 270, and fulfills rewards or offers earned by the members 270. The members 270, on the other hand, can check their available offers (e.g., check point balance), redeem rewards (i.e., offers, such as points or products), and make customer service calls related to the loyalty program to the marketing component 260. Additionally, the host or host website 265 and host marketing component 260 can transact to such that the host marketing component 260 can communicate reporting and marketing information to the host or host website 265, and the host or host website 265 can communicate member information to the host marketing component 260.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for providing a customer loyalty program, wherein at least one consumer purchases one or more goods or services from at least one partner, and wherein the at least one partner collects transaction information about the at least one consumer's purchase from a point of sale terminal, comprising:
a host in communication with the at least one consumer and the at least one partner, wherein said host maintains a transaction history of said at least one consumer, said transaction history including said transaction information, wherein said host generates partner segments to which said at least one loyalty program partner is assigned, and wherein the host is operable to dynamically generate at least one offer for said at least one consumer based on said transaction history and the partner segment to which said at least one partner is assigned.

2. The system of claim 1, wherein said host is operable to generate an offer based at least in part upon criteria provided to the host from the at least one loyalty program partner.

3. The system of claim 1, wherein said host and said partner are in electrical communication via a communication mechanism selected from the group consisting of the Internet, a public switch telephone network, and a wireless network.

4. The system of claim 1, further comprising a host marketing module, in communication with said host, wherein the host marketing module is operable to present said at least one offer to said at least one consumer.

5. The system of claim 1, wherein said host is operable to generate reports based on said transaction history of said at least one consumer.

6. The system of claim 5, wherein said host is operable to provide said reports to said at least one partner such that criteria received by said host from said at least one partner is at least partially based on said reports, and wherein said criteria is utilized by said host to generate said at least one offer.

7. The system of claim 1, wherein said host comprises at least one database for storing said transaction history.

8. The system of claim 1, wherein said host comprises at least one automated interface with which said at least one consumer can communicate to view the at least one offer.

9. The system of claim 1, wherein said host is operable to identify said at least one consumer based on said transaction information provided by said partner.

10. The system of claim 9, wherein said host is operable to forward identification information identifying said at least one consumer to said at least one partner, wherein said identification information is forwarded to said at least one partner prior to said at least one consumer purchasing goods or services from said partner.

11. A system, for providing a customer loyalty program, comprising:
at least one consumer;
at least one loyalty program partner, from which the at least one consumer purchases one or more goods or services, wherein the at least one partner collects transaction information about the at least one consumer's purchase from a point of sale terminal;
a host, in communication with the at least one consumer and the at least one royalty program partner, wherein the host receives the transaction information from the loyalty program partner, wherein the host rewards the consumer for purchasing the one or more goods or services, and wherein the reward is based at least in part upon criteria provided to the host from the at least one loyalty program partner.

12. An incentive system, for rewarding consumers for purchasing one or more goods, comprising:
a consumer;
a host, in communication with the at least one consumer; and
a partner, in communication with the consumer and the host, wherein the host provides an offer to the consumer, the offer being generated in part by the partner, wherein the offer results in a reward to the consumer from the host when the consumer purchases one or more goods or services from the partner, and wherein the reward may be redeemed by the consumer from the host.

13. The system of claim 12, wherein said partner is selected from the group consisting of a retailer, consumer packaged goods company, grocery store, and service provider.

14. A method for rewarding consumers for purchasing one or more goods. comprising:
registering a consumer as a member of a reward system;
forwarding identification information corresponding to said consumer to at least one partner;
receiving transaction information from said at least one partner, wherein said transaction information comprises at least a portion of said identification information corresponding to said consumer, and wherein said transaction information is generated by said at least one partner during a sale transaction with said at least one consumer;
identifying said consumer;
retrieving a profile associated with said consumer, wherein said profile includes a partner segment to which said consumer is assigned;
dynamically generating an offer to said consumer based at least in part upon said profile and said transaction information; and
making said offer available to said consumer.

15. The method of claim 14, further comprising storing a consumer purchase history, wherein said consumer purchase history includes transaction information received from each partner with which said consumer transacts.

16. The method of claim 15, further comprising preparing reports based upon said consumer purchase history, and forwarding said reports to said at least one partner.

17. The method of claim 16, wherein said step of preparing reports comprises preparing reports in real-time in response to partner requests for said reports.

18. The method of claim 14, wherein the step of dynamically generating an offer comprises dynamically generating an offer based at least in part upon said partner segment to which said consumer is assigned.

19. The method of claim 18, wherein the step of retrieving a profile associated with said consumer, comprises retrieving a profile including a partner segment defined by said at least one partner.

20. The method of claim 14, wherein the step of receiving transaction information comprises receiving transaction information generated by said at least one partner during a sale transaction with said at least one consumer based upon a membership card or credit card associated with said host.

21. The method of claim 14, wherein the step of registering said consumer comprises registering said consumer via a registration mechanism selected from the group consisting of an Internet web site, telephone and form.

22. A system for providing a customer loyalty program, wherein at least one consumer purchases one or more goods or services from at least one partner, and wherein the at least one partner collects transaction information about the at least one consumer's purchase from a point of sale terminal, comprising:
a host in communication with the at least one consumer and the at least one partner, wherein said host generates partner segments to which said at least one loyalty program partner is assigned, and wherein the host is operable to dynamically generate at least one offer for said at least one consumer based on the partner segment to which said at least one partner is assigned.

23. The system of claim 22, wherein said host is operable to dynamically generate at least one offer for said at least one consumer based on demographic information associated with said at least one consumer.

24. The system of claim 22, wherein said host is operable to dynamically generate at least one offer for said at least one consumer based on consumer provided identification information associated with said at least one consumer.

25. The system of claim 22, wherein said host is operable to dynamically generate at least one offer for said at least one consumer based on third party information associated with one of said at least one consumer and said at least one partner, and wherein said third party information is provided by a third party in communication with said host.
